(19) United States
(12) Patent Application Publication
(10) Pub. No.: US 2011/0115719 A1
(43) Pub. Date: May 19, 2011

(54) HANDHELD INPUT DEVICE FOR FINGER TOUCH MOTION INPUTTING

(76) Inventor: Ka Pak Ng, Hong Kong (HK)

(21) Appl. No.: 12/619,687

(22) Filed: Nov. 17, 2009

(51) Int. Cl. G06F 3/041

(52) U.S. Cl. 345/173

(57) ABSTRACT

A handheld input device includes a housing and first and second groups of touch movement sensors provided respectively at two opposite sides of the housing on a bottom surface thereof. The first and second groups of touch movement sensors are sized and shaped to be accessible by the fingers of the two hands of an operator holding the housing at the two opposite sides.

The present application relates to a handheld input device for data entry by the touch motion of fingers of an operator.

### BACKGROUND

Traditionally, computing device is a desktop and the most usual input devices are keyboard and mouse. As mobility and network connection have become more and more important in this new era, laptop computer is getting more popular but it is not the end of the evolution. Smaller hand-held computers such as netbook and PDA are getting more popular nowadays for personal and business purpose. Most people use them for MSN, E-Mail, Web-surfing and document/book reading. Owing to small physical size of the hand-held electronic computing device, the operation is not convenient and efficient in most of the cases. For character input, an operator has to either look up to the miniature keyboard for the right character or use pen to input in a virtual keyboard on the screen. However, those input devices degrade the speed of typing compared with conventional keyboard and also operator cannot concentrate on the display screen. Also, owing to the limited size of the keyboard on a portable device, it is not suitable for thumb-typing.

In view of these difficulties, there is a need to produce a handheld input device operable by finger touch motion. A handheld input device for finger touch motion can facilitate an operator to operate his/her hand-held electronic computing device only with finger motion no matter he/she is in the office, on the transportation system, or in any other places. An operator can fully operate his/her hand-held electronic computing device with an efficient and convenient way.

The above description of the background is provided to aid in understanding a handheld input device, but is not admitted to describe or constitute pertinent prior art to the handheld input device disclosed in the present application, or consider any cited documents as material to the patentability of the claims of the present application.

### SUMMARY

According to one aspect, there is provided a portable computer including a housing, a display screen connected to the housing, and first and second groups of touch movement sensors having generally parallel elongated sensing surfaces. The housing includes a top surface generally facing an operator during inputting and a bottom surface generally facing away from the operator during inputting. The first and second groups of touch movement sensors are provided respectively at the two opposite sides of the housing on the bottom surface thereof. The sensors are sized and shaped to be accessible by the fingers of the two hands of the operator holding the housing at the two opposite sides.

In one embodiment, the first group of touch movement sensors includes first, second, third and fourth touch movement sensors accessible by the left index finger, left middle finger, left ring finger and left little finger respectively; and wherein the second group of touch movement sensors comprises first, second, third and fourth touch movement sensors accessible by the right index finger, right middle finger, right ring finger and right little finger respectively.

In one embodiment, the first group of touch movement sensors further includes a fifth touch movement sensor adjacent to the first touch movement sensor in the first group and accessible by the left index finger; and wherein the second group of touch movement sensors further comprises a fifth touch movement sensor adjacent to the first touch movement sensor in the second group and accessible by the right index finger.

In one embodiment, the touch movement sensors are touch and two-directional movement sensors for detecting the touching of the fingers as well as the movement of the fingers in the forward and backward directions along the elongated sensing surfaces of the sensors. Each elongated sensing surface has a concaved cross section and has a width of a finger.

The portable computer may further include two touch pads provided at the two opposite sides of the housing on a top surface thereof for operation by the two thumbs of the operator respectively, a conventional keyboard provided on a top surface of the housing, a wired or wireless digital interface for connecting the portable computer to another device, and a program for changing the matching of key events to characters and functions.

The first and second groups of touch movement sensors are connected to a processing unit, which is in turn connected to a host. Different finger actions on different touch movement sensors are decoded as different key events each corresponding to a character or a function. The finger actions start at any initial touch point on the touch movement sensors.

The display screen may be pivotally connected to the housing by a hinge allowing the display screen to flip forward and backward as well as rotate 180 degrees. The angle between the display screen and the housing may be about 90-180 degrees when the operator is holding the housing at a substantially horizontal position while inputting. The angle between the display screen and the housing may be about 160 degrees. The angle between the display screen and the housing is about 180-270 degrees when the operator is holding the housing at a substantially vertical position while inputting. The angle between the display screen and the housing may be about 220 degrees. The angle between the display screen and the housing may be about 0-90 degrees when the operator is holding the housing at a substantially vertical position while inputting and the display screen is rotated 180 degrees. The angle between the display screen and the housing may be about 40 degrees.

According to another aspect, there is provided a handheld input device including a housing and first and second groups of touch movement sensors provided respectively at two opposite sides of the housing on a bottom surface thereof. The first and second groups of touch movement sensors are sized and shaped to be accessible by the fingers of the two hands of an operator holding the housing at the two opposite sides. Each group of touch movement sensors may include generally parallel elongated sensing surfaces.

The device includes memory space for buffering a recent key event to yield combination key events. The key event is stored in a memory buffer with an expiry mechanism based on the individual lifespan and time stamp of the key event. The sensors detect concurrent movement of fingers of both hands of the operator for character/function decoding to the host. The finger actions include “touch and release”, “touch, move to the left, and then release” and “touch, move to the right, and then release”.

Although the handheld input device disclosed in the present application is shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the handheld input device disclosed in the present application will now be described by way of example with reference to the accompanying drawings wherein:

FIG. 1a is a top plan view of the handheld input device according to an embodiment disclosed in the present application.

FIG. 1b is a top plan view of the handheld input device with an optional mini keyboard.

FIG. 2 is a bottom view of the handheld input device according to an embodiment disclosed in the present application.

FIG. 3 is a block diagram showing the connection between the sensors, the processing unit and the host.

FIGS. 4a, 4b, 5a, and 5b are the definition of forward and backward movement of the left and right fingers.

FIG. 6 is a top plan view of the handheld input device with indication of operator's hands holding the portable device.

FIG. 7 is the demonstration of a unified input device for operator's hands of different sizes.

FIG. 8 is a key event table for the left and right hands.

FIG. 9 is a front perspective view of the handheld input device in a portable device.

FIG. 10 is a left side view of the handheld input device in a portable device.

FIG. 11 is a right side view of the handheld input device in a portable device.

FIGS. 12a, 12b, 13a, 13b, 14a, and 14b are the finger movement indications for key events F1-F6.

FIGS. 15a, 15b, 16a, 16b, 17a, and 17b are the finger movement indications for key events L1-L3 and R1-R3.

FIGS. 18a, 18b, 19a, 19b, 20a, and 20b are the finger movement indications for key events L4-L15 and R4-R15.

FIGS. 21a, 21b, 22a, 22b, 23a, and 23b are the finger movement indications for key events L16-L18 and R16-R18.

FIGS. 24a and 24b are the demonstration of a first holding position 1 for an operator to operate the handheld input device.

FIGS. 25a and 25b are the demonstration of a second holding position for an operator to operate the handheld input device.

FIGS. 26a and 26b are the demonstration of a third holding position for an operator to operate the handheld input device.

FIG. 27 is the key event matching to different character/function keys for 3 separate modes.

FIG. 28 is the operation flow to decode finger movement to key event.

FIG. 29 is the operation flow to output character/function to host.

FIG. 30 is the operation flow to input data from touch movement sensors.

### DETAILED DESCRIPTION

Reference will now be made in detail to a preferred embodiment of the handheld input device disclosed in the present application, examples of which are also provided in the following description. Exemplary embodiments of the handheld input device disclosed in the present application are described in detail, although it will be apparent to those skilled in the relevant art that some features that are not particularly important to an understanding of the handheld input device may not be shown for the sake of clarity.

Furthermore, it should be understood that the handheld input device disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

In addition, improvements and modifications which may become apparent to persons of ordinary skill in the art after reading this disclosure, the drawings, and the appended claims are deemed within the spirit and scope of the appended claims.

Certain terminology is used in the following description for convenience only and is not limiting. The words “left”, “right”, “upper”, “lower”, “top”, and “bottom” designate directions in the drawings to which reference is made. The terminology includes the words noted above as well as derivatives thereof and words of similar import.

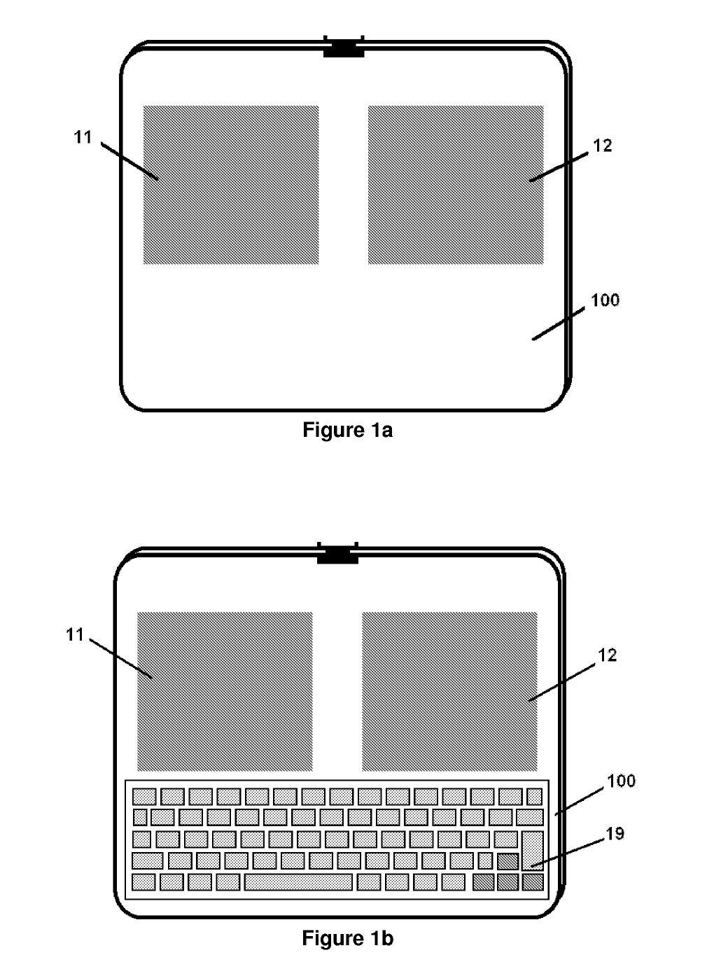

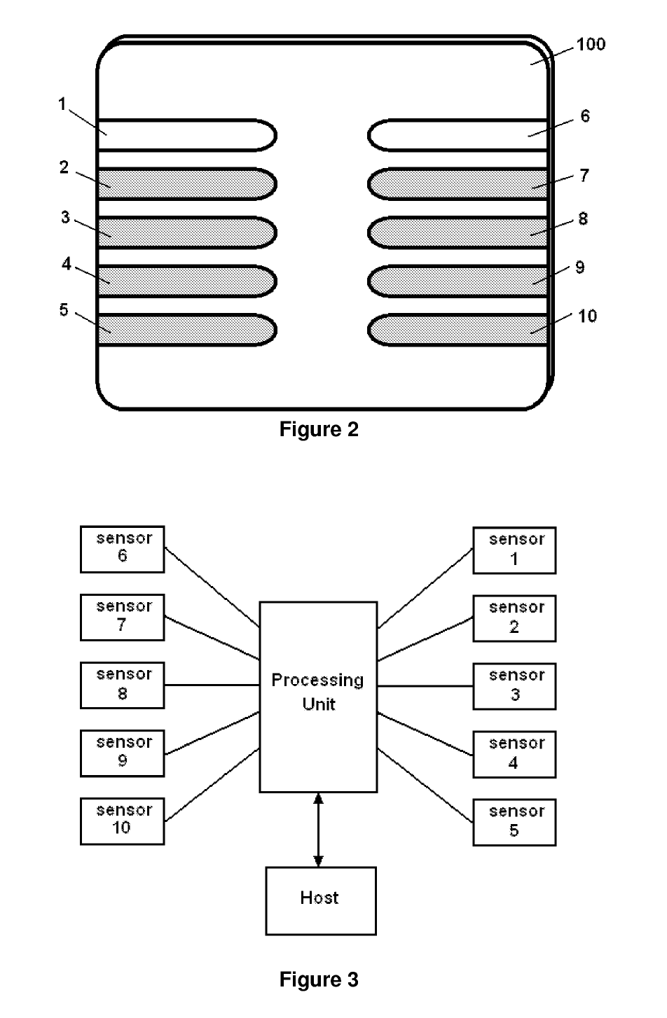

FIGS. 1a and 2 show a handheld input device according to an embodiment disclosed in the present application. The handheld input device for finger touch motion input 100 may include two touch pad sensors 11, 12 located at the top surface of the device and ten touch movement sensors 1, 2, 3, 4, 5, 6, 7, 8, 9, 10 located at the bottom surface of the device. The touch movement sensors at the bottom surface may be connected to a processing unit for character or function key decoding and sending output to the host.

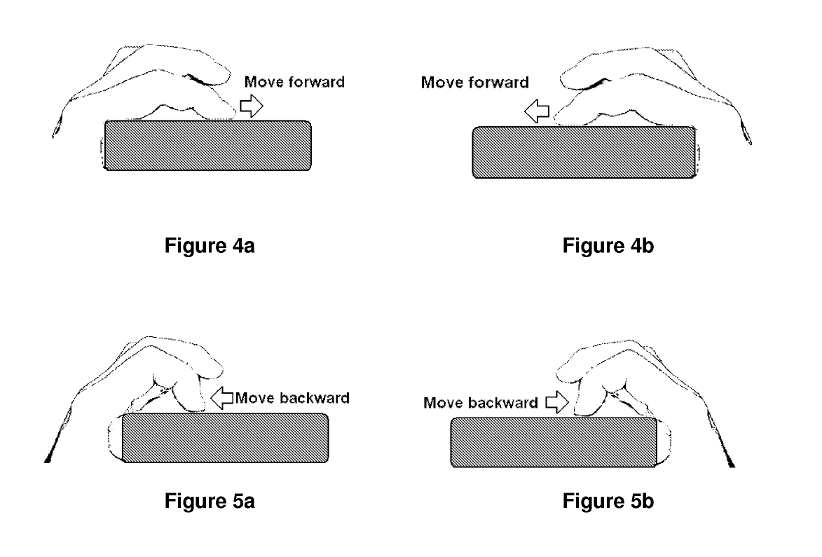

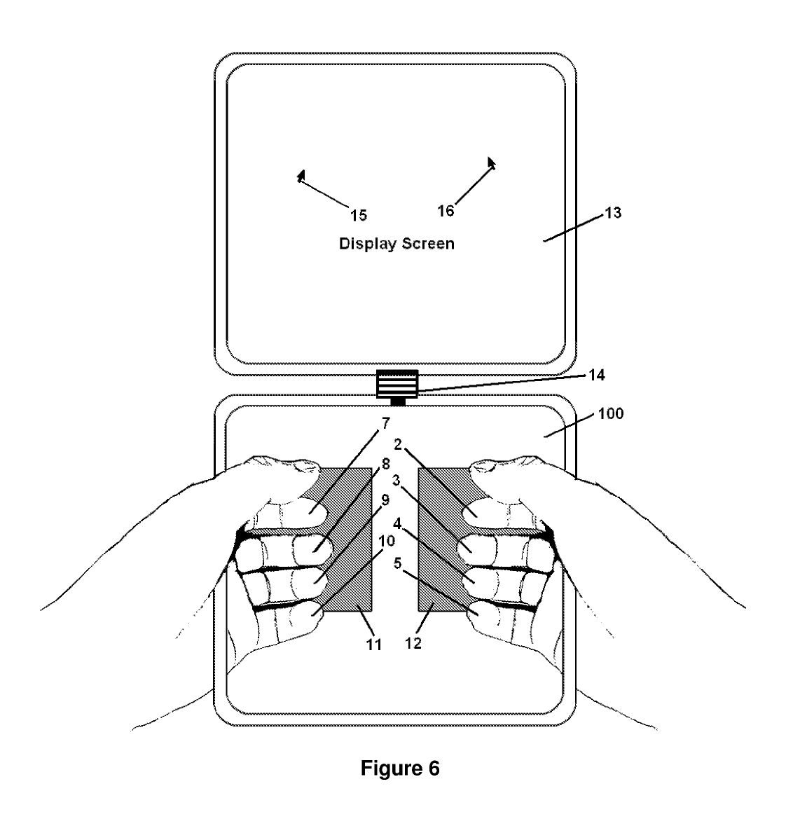

FIG. 3 is a block diagram showing the connection between the sensors, the processing unit and the host. Each character or function key can be represented by forward movement, backward movement and stroke of the fingers. As used herein, the term “forward movement” means the movement of the finger tip on the sensor away from the palm, as shown in FIGS. 4a and 4b. As used herein, the term “backward movement” means the movement of the finger tip on the sensor towards the palm, as shown in FIG. 5a and FIG. 5b. As used herein, the term “stroke” is the movement of finger tip to touch and release the sensor.

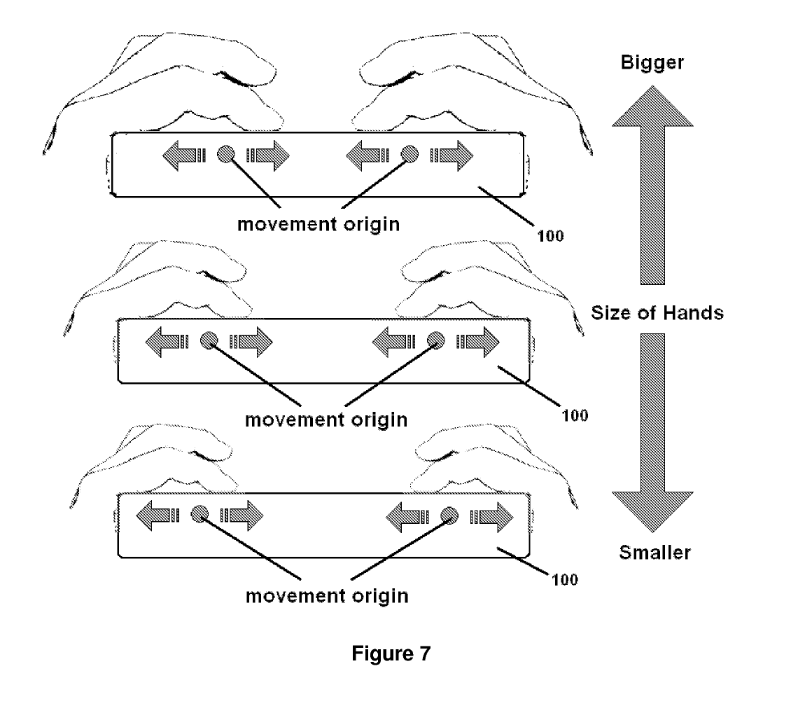

An advantage of the handheld input device for finger touch motion is that it can be suitable for all operators with different sizes of hands to find the most comfortable position as shown in FIG. 7. Since only the movement of the finger on the sensor is considered, the initial touch on the sensor can be at any point along the strip of sensor.

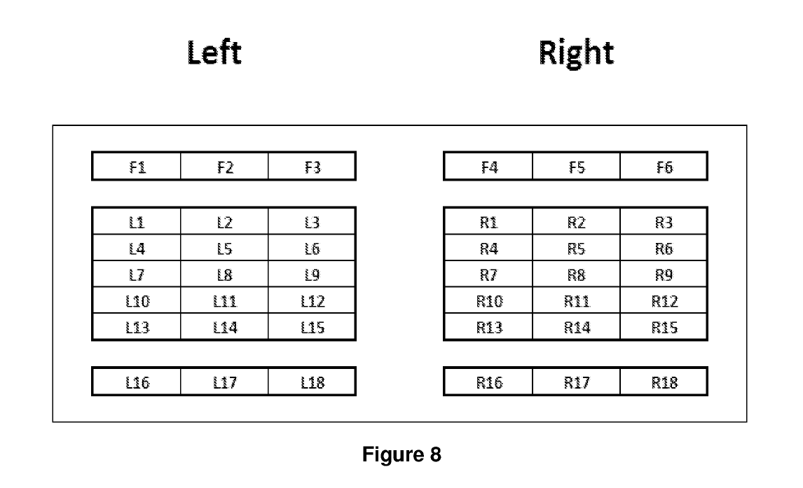

According to the illustrated embodiment, there are 21 key events in total for each hand. The assignment of key events in FIG. 8 can be mapped with different finger movements listed in the following Tables 1 and 2. Table 1 shows the relevant triggering action of the operator's left hand matching to different key events. Table 2 shows the relevant triggering action of the operator's right hand matching to different key events.

TABLE 1

| Key | | Refer |
|---|---|---|
| event | Triggering action | to |
| F1 | sensor 6 detect that Index finger touches and moves backward | FIG. |
| | (left) and then releases | 12a |
| F2 | sensor 6 detects that Index finger has a stroke and releases | FIG. |
| | | 13a |
| F3 | sensor 6 detects that Index finger touches and moves forward | FIG. |
| | (right) and then releases | 14a |
| L1 | sensor 7 and sensor 8 detect that both Index finger and Middle | FIG. |
| | finger touch and move backward (left) and then release | 15a |
| L2 | sensor 7 and sensor 8 detect that both Index finger and Middle | FIG. |
| | finger have a stroke and release | 16a |
| L3 | sensor 7 and sensor 8 detect that both Index finger and Middle | FIG. |
| | finger touch and move forward (right) and then release | 17a |
| L4 | sensor 7 detect that Index finger touches and moves backward | FIG. |
| | (left) and then releases | 18a |
| L5 | sensor 7 detects that Index finger has a stroke and releases | FIG. |
| | | 19a |
| L6 | sensor 7 detects that Index finger touches and moves forward | FIG. |
| | (right) and then releases | 20a |
| L7 | sensor 8 detect that Middle finger touches and moves backward | FIG. |
| | (left) and then releases | 18a |
| L8 | sensor 8 detects that Middle finger has a stroke and releases | FIG. |
| | | 19a |
| L9 | sensor 8 detects that Middle finger touches and moves forward | FIG. |
| | (right) and then releases | 20a |
| L10 | sensor 9 detect that Ring finger touches and moves backward | FIG. |
| | (left) and then releases | 18a |
| L11 | sensor 9 detects that Ring finger has a stroke and releases | FIG. |
| | | 19a |
| L12 | sensor 9 detects that Ring finger touches and moves forward | FIG. |
| | (right) and then releases | 20a |
| L13 | sensor 10 detect that Little finger touches and moves backward | FIG. |
| | (left) and then releases | 18a |
| L14 | sensor 10 detects that Little finger has a stroke and releases | FIG. |
| | | 19a |
| L15 | sensor 10 detects that Little finger touches and moves forward | FIG. |
| | (right) and then releases | 20a |
| L16 | sensor 7, 8, 9, 10 detect that Index, Middle, Ring and little fingers | FIG. |
| | touch and move backward (left) and then release | 21a |
| L17 | sensor 7, 8, 9, 10 detect that Index, Middle, Ring and little fingers | FIG. |
| | have a stroke and release | 22a |
| L18 | sensor 7, 8, 9, 10 detect that Index, Middle, Ring and little fingers touch and | FIG. |
| | move forward (right) and then release | 23a |
| H1 | L16 and R18 | |
| H2 | L18 and R16 | |

TABLE 2

| Key | | Refer |
|---|---|---|
| event | Triggering action | to |
| F4 | sensor 1 detect that Index finger touches and moves forward | FIG. |
| | (left) and then releases | 14b |
| F5 | sensor 1 detects that Index finger has a stroke and releases | FIG. |
| | | 13b |
| F6 | sensor 1 detects that Index finger touches and moves backward | FIG. |
| | (right) and then releases | 12b |
| R1 | sensor 2 and sensor 3 detect that both Index finger and Middle | FIG. |
| | finger touch and move forward (left) and then release | 17b |
| R2 | sensor 2 and sensor 3 detect that both Index finger and Middle | FIG. |
| | finger have a stroke and release | 16b |
| R3 | sensor 2 and sensor 3 detect that both Index finger and Middle | FIG. |
| | finger touch and move backward (right) and then release | 15b |
| R4 | sensor 2 detect that Index finger touches and moves forward | FIG. |
| | (left) and then releases | 20b |
| R5 | sensor 2 detects that Index finger has a stroke and releases | FIG. |
| | | 19b |
| R6 | sensor 2 detects that Index finger touches and moves backward | FIG. |
| | (right) and then releases | 18b |
| R7 | sensor 3 detect that Middle finger touches and moves forward | FIG. |
| | (left) and then releases | 20b |
| R8 | sensor 3 detects that Middle finger has a stroke and releases | FIG. |
| | | 19b |
| R9 | sensor 3 detects that Middle finger touches and moves backward | FIG. |
| | (right) and then releases | 18b |
| R10 | sensor 4 detect that Ring finger touches and moves forward (left) | FIG. |
| | and then releases | 20b |
| R11 | sensor 4 detects that Ring finger has a stroke and releases | FIG. |
| | | 19b |
| R12 | sensor 4 detects that Ring finger touches and moves backward | FIG. |
| | (right) and then releases | 18b |
| R13 | sensor 5 detect that Little finger touches and moves forward | FIG. |
| | (left) and then releases | 20b |
| R14 | sensor 5 detects that Little finger has a stroke and releases | FIG. |
| | | 19b |
| R15 | sensor 5 detects that Little finger touches and moves backward | FIG. |
| | (right) and then releases | 18b |
| R16 | sensor 2, 3, 4, 5 detect that Index, Middle, Ring and little fingers | FIG. |
| | touch and move forward (left) and then release | 23b |
| R17 | sensor 2, 3, 4, 5 detect that Index, Middle, Ring and little fingers | FIG. |
| | have a stroke and release | 22b |
| R18 | sensor 2, 3, 4, 5 detect that Index, Middle, Ring and little fingers touch and | FIG. |
| | move backward (right) and then release | 21b |
| H1 | L16 and R18 | |
| H2 | L18 and R16 | |

An operator can change the mapping between each key event and key response of character/function according to his/her own preference by a program. Optionally, a pop up table with the current key assignment can be displayed at the lower part of the display screen upon user's request by additional key event H1 and H2 for revealing and hiding respectively.

In order to facilitate adaptation, the handheld input device of the present application can apply similar matching of characters to fingers to the matching of a conventional keyboard. Furthermore, the handheld input device of the present application can be applied to a device with Text-to-Speech system for people who are mute. It can help them to communicate with normal people who are not familiar with sign language.

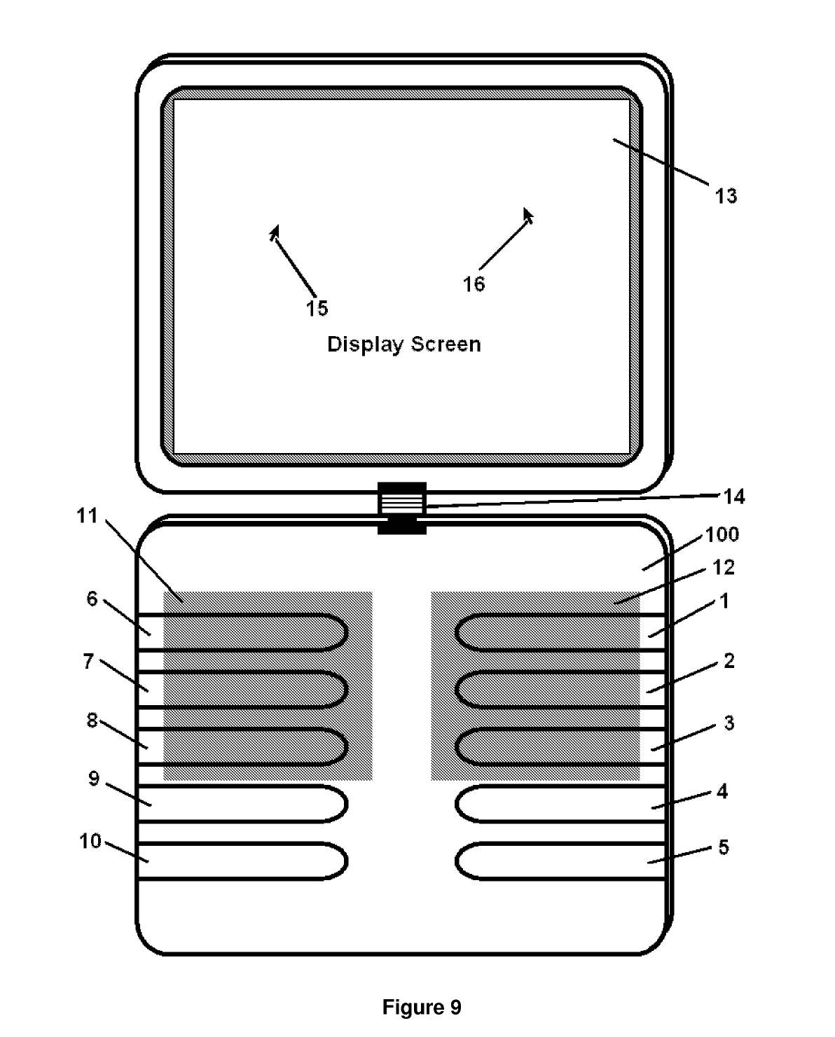

The handheld input device using finger touch motion can be integrated into a portable computer such as a netbook as shown in FIG. 9. The embodiment 100 of the device is connected to a LCD display screen 13 with a hinge 14 which can be flipped forward and backward as well as turned 180 degrees. Also there is enough space below the two touch pad sensors 11, 12 so that the optional mini-sized keyboard 19 can be integrated for operation on a desktop as shown in FIG. 1b.

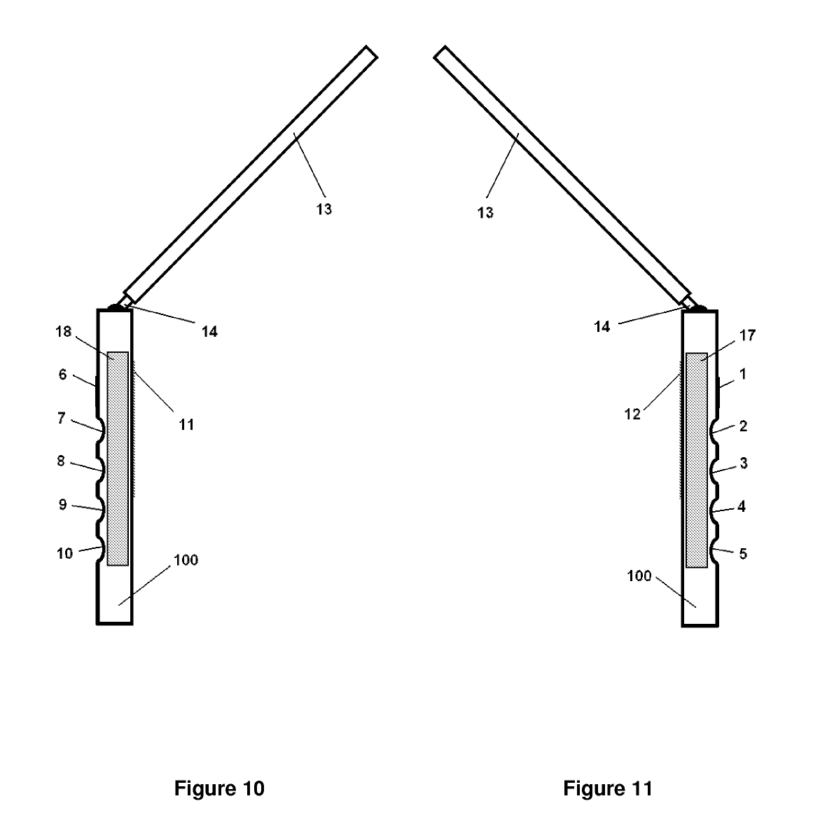

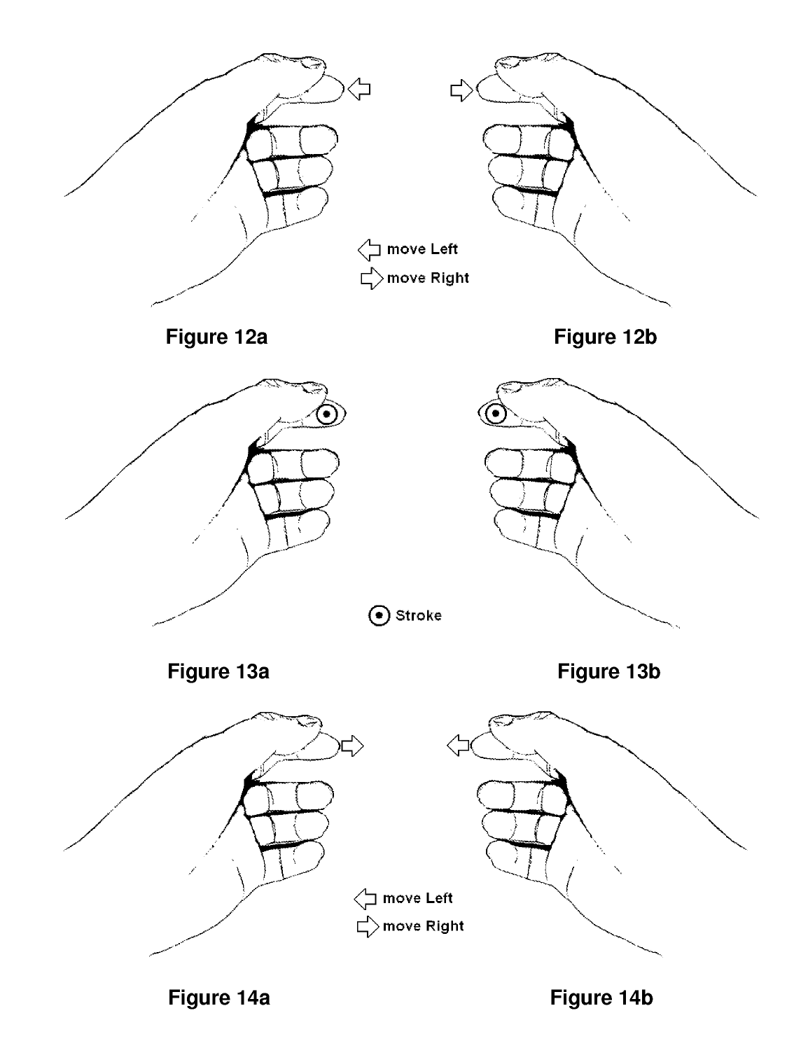

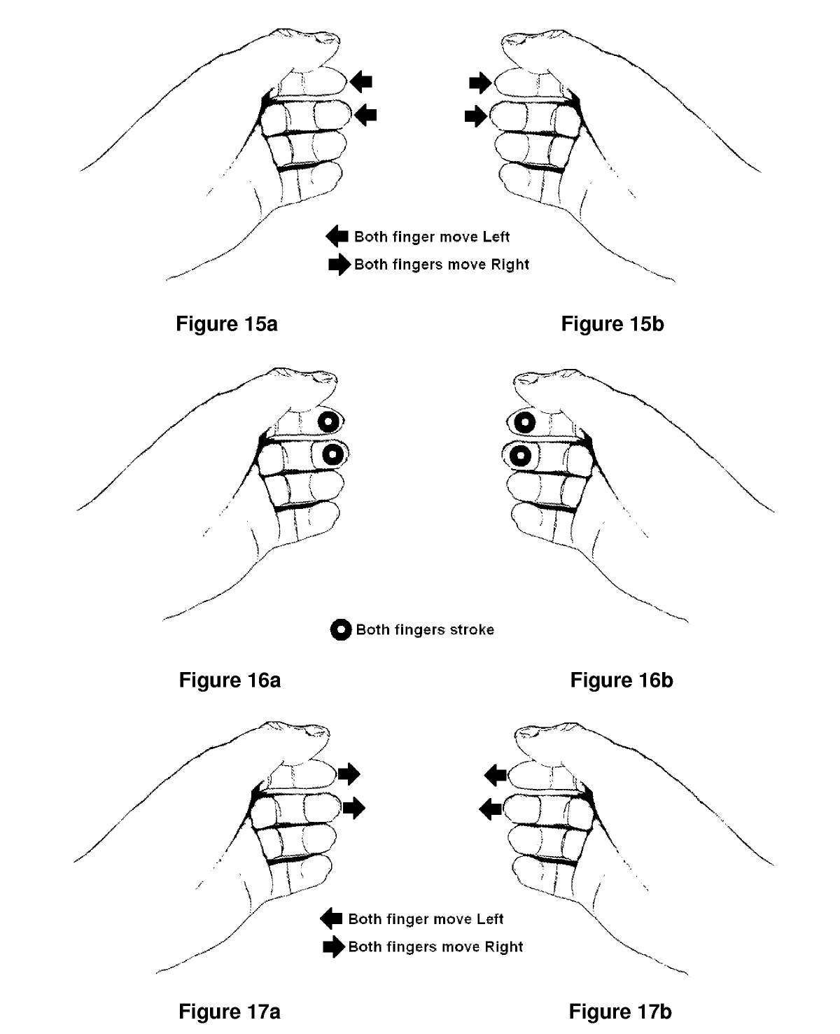

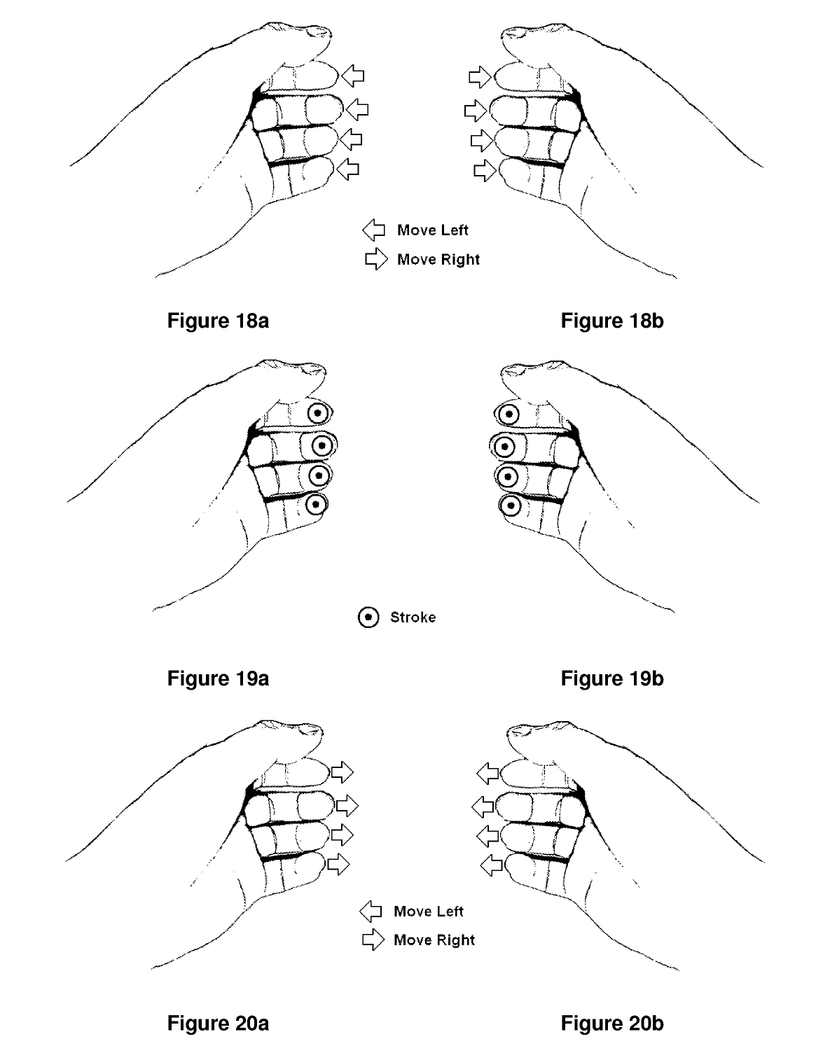

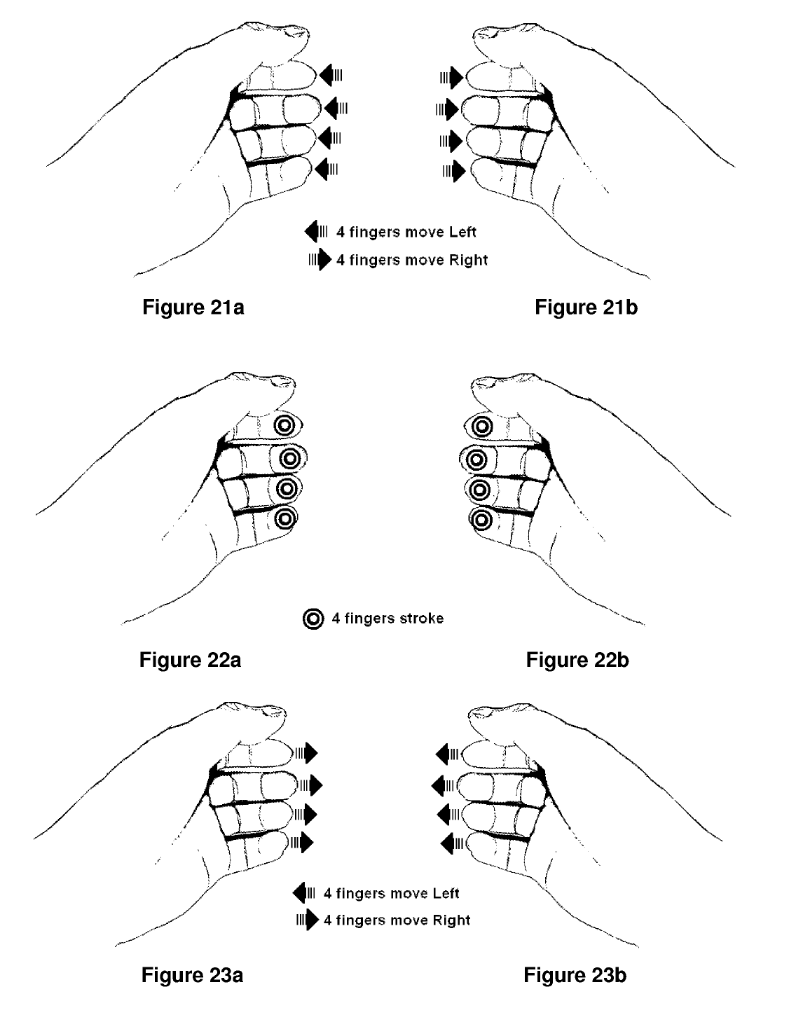

As shown in FIGS. 10 and 11, the sensors 2, 3, 4, 5, 7, 8, 9 and 10 may have generally parallel elongated sensing surfaces with arc-shaped or concaved cross section so as to assist an operator to locate his/her fingers in the right positions. Sensor 1 and sensor 6 may have flat surfaces which can be accessed by the index fingers. Both the left and right sides of the portable device with the handheld input device for finger touch motion input may be provided with anti-slip pads 17, 18 to prevent the device 100 from slipping from the hands of the operator. The operator can hold the device 100 by exerting pressure on the anti-slip pads 17, 18 on the left and right sides with both his/her left and right palms. The operator's index finger, middle finger, ring finger and little finger of the right hand can be placed under the sensors 2, 3, 4, 5 respectively. The operator's index finger, middle finger, ring finger and little finger of the left hand can be placed under the sensors 7, 8, 9, 10 respectively. Sensor 1 and sensor 6 can be operable with the right and left index fingers respectively.

Although it has been shown and described that the sensors are arranged parallel to one another, it is understood by one skilled in the art that the sensors may be arranged in other possible orientation. For example, the sensors on the left may be arranged at an angle with respect to the sensors on the right.

The position of the input sensors is designed to fit human hands in an ideal way to operate the handheld electronic computing device for data entry. The size of the hand of an operator will not affect the operation as it can be adjustable by the operator as necessary. When an operator needs to type characters or numbers into the handheld electronic computing device, the operator can fully make use of eight of his/her fingers and leave the thumbs to control the pointer on the display screen.

The two touch pad sensors 11 and 12 can be operable by the left and right thumbs respectively. Dual cursor and pointer can be achieved with two separate touch pads for simultaneously moving two objects or pointers on the left and right sides of the display screen 13. The operator does not have to release the pointer while inputting data. This allows an operator to operate a pointer while inputting data. The operator can even operate two pointers simultaneously with the left and right side touch pads on the top surface of the device.

As there is no drag and click button available, the touch pad is able to determine the pressure of the thumbs in two steps, so as to determine the trigger of click and drag. As used herein, the term “Click” means slightly increase the pressing force to the touch pad in a short predefined interval, the term “Double Click” means slightly increase the pressing force to the touch pad in a short predefined interval twice, and the term “Drag” means slightly increase the pressing force to the touch pad with the time interval exceeding a predefined period and then move.

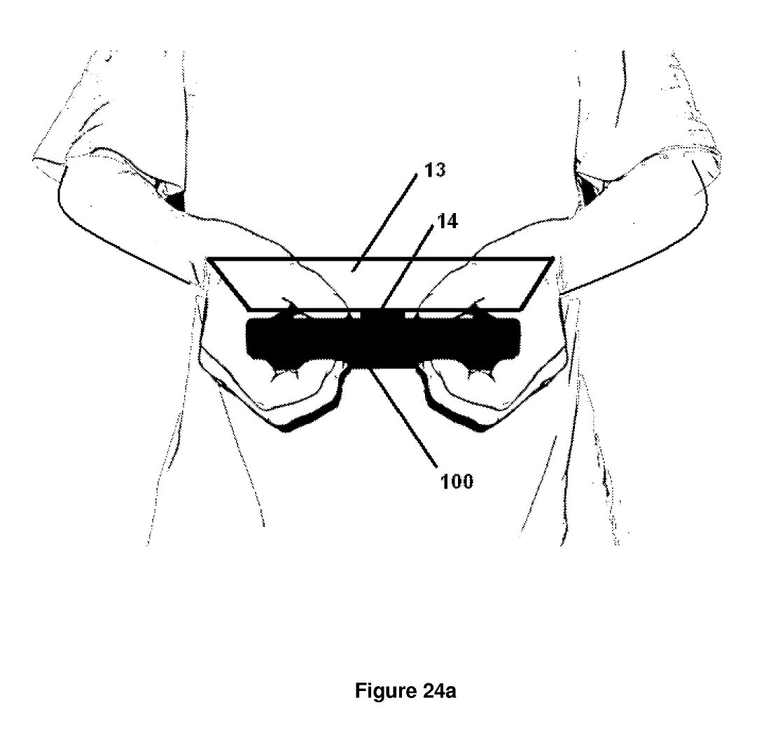

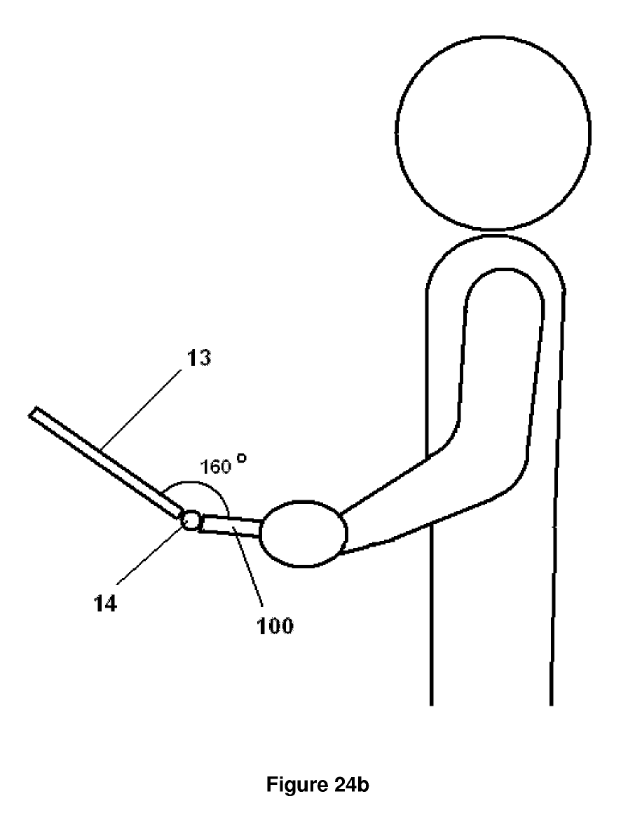

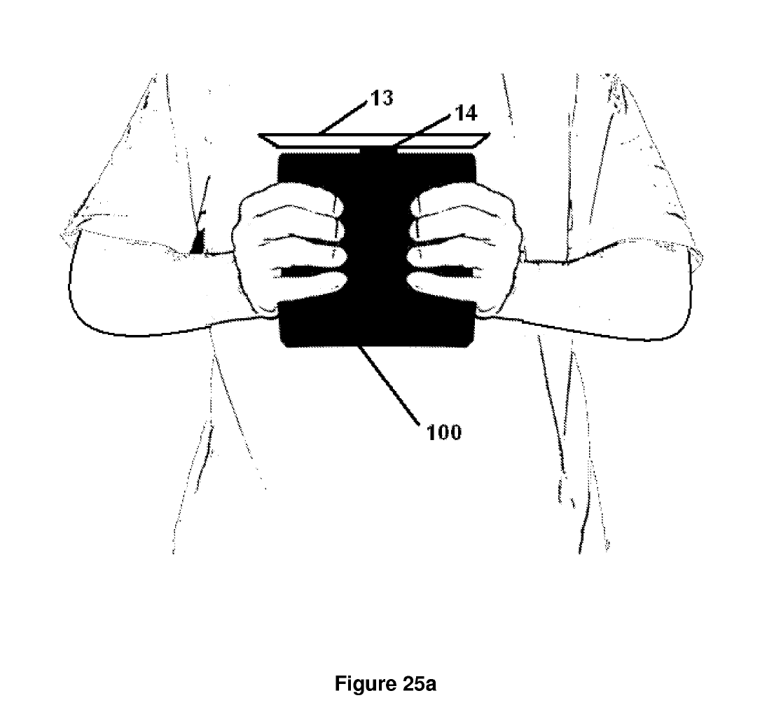

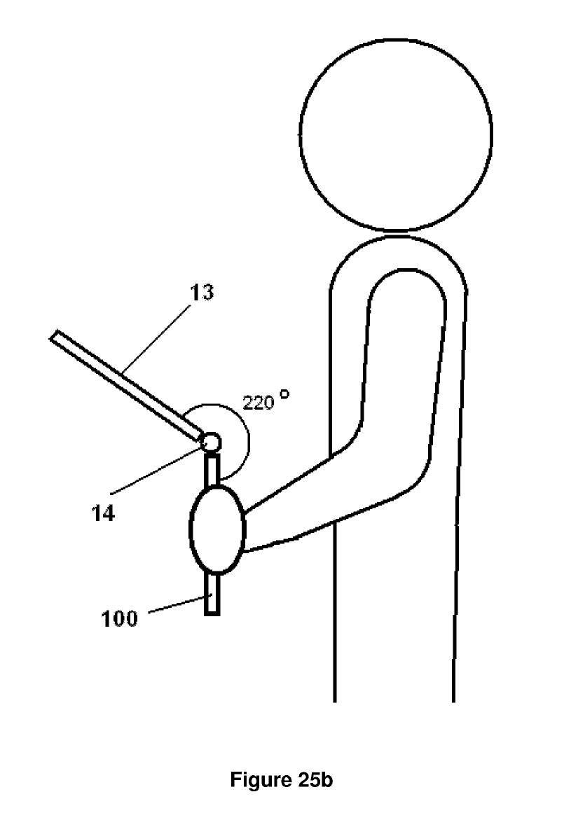

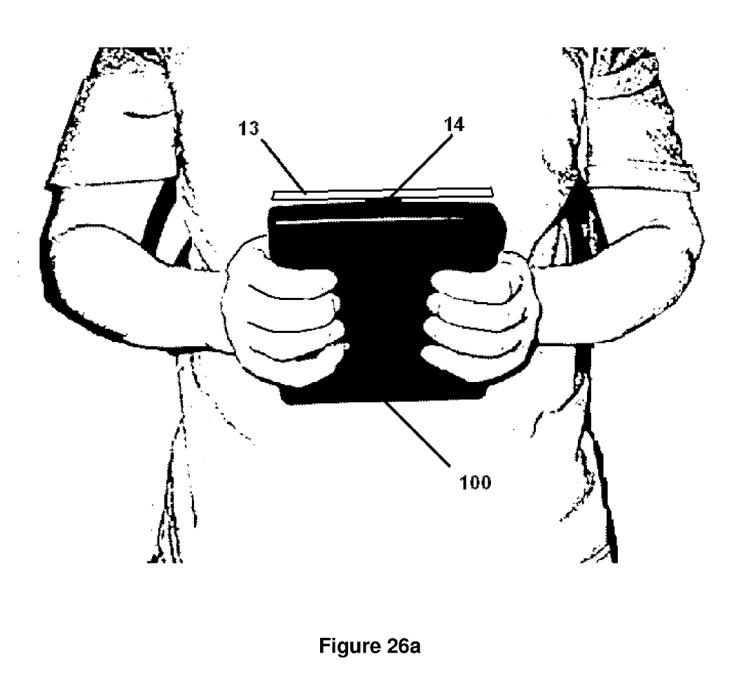

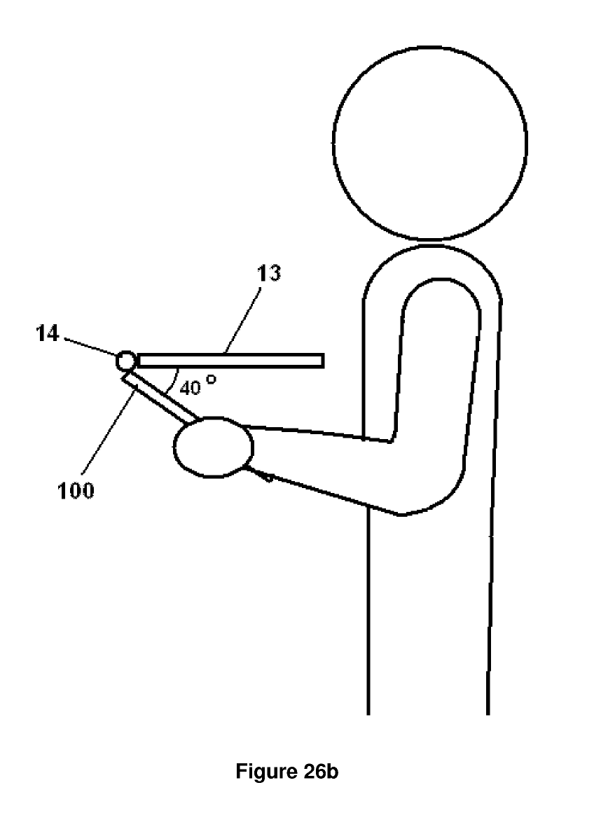

Since the hinge 14 between the main body or housing of the portable device 100 and the display screen 13 can be flipped backwards and forwards as well as rotated 180 degrees, the portable device with the handheld input device for finger touch motion input can be operated in three different positions. An operator can just flip the display screen 13 at about 160 degrees (or between about 90-180 degrees) as shown in FIGS. 24a and 24b. Also, the display screen 13 can be flipped about 220 degrees (or between about 180-270 degrees) and the operator can hold the device in a vertical position as shown in FIGS. 25a and 25b. In a very narrow space, an operator can turn the display screen 13 from left to right by 180 degrees and flip the display screen 13 at about 40 degrees (or between about 0-90 degrees) as shown in FIGS. 26a and 26b.

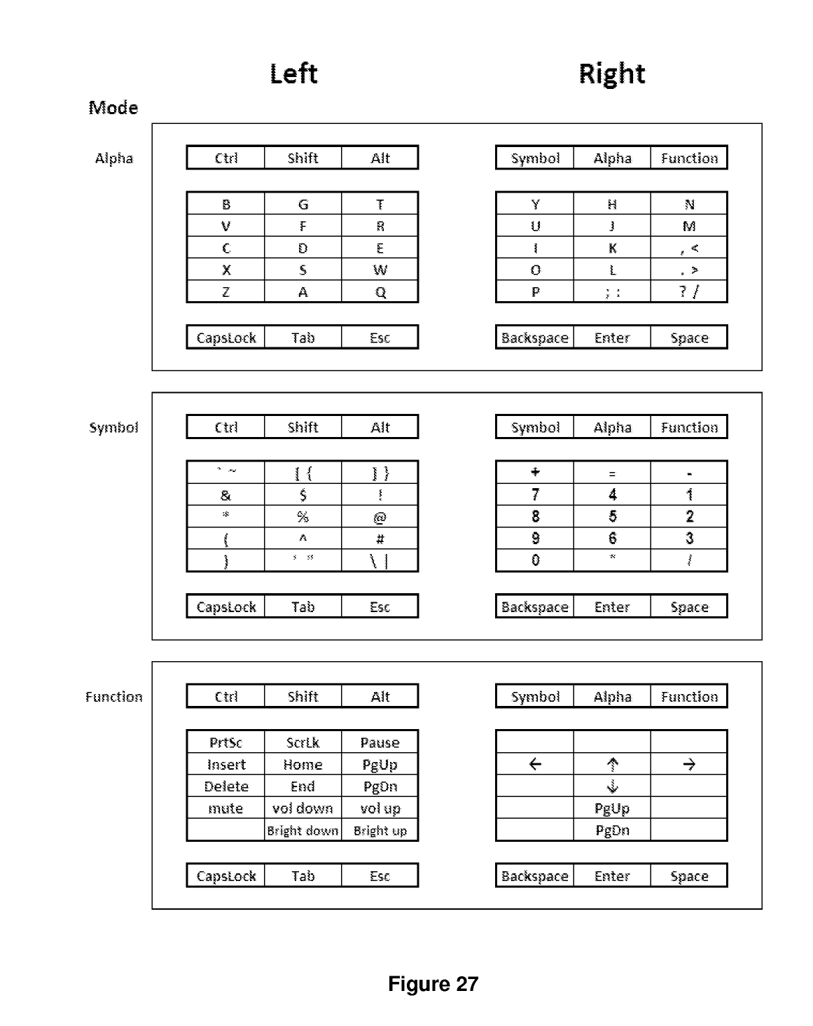

There are 3 modes of operation on the handheld input device for finger touch motion input. It can be changed by the operator with key event F4, F5, and F6 for Symbol, Alpha and Function mode respectively. The output response of the key event for L1-L15 and R1-R15 can be different according to the current state of the mode. The character and function key output mapping to the key event in Alpha, Symbol and Function mode are indicated in FIG. 27.

Key events can be categorized into 3 types. The first type is single touch, the second type is multi-touch, and the third type is for key combination with the technique of extended time response.

The first type can be applied to key event L4-L15, R4-R15, and F4-F6. It is supposed to have immediate output response to this type of key event right after release of the triggering finger from the sensor.

The second type can be applied to key event L1-L3, L16-L18, R1-R3, R16-R18 triggered by double or multiple finger movement. The main characteristic of it is the definition of time difference tolerance among different fingers' movement.

The third type can be applied to Key F1-F3. It provides an effective means for press and hold key of “Alt” and “Ctrl” and “Shift” to simulate double or triple key press. It is especially useful for
1) Press “Alt”+any other key
2) Press “Ctrl”+any other key
3) Press “Shift”+any other key
4) Press “Ctrl”+“Alt”+any other key

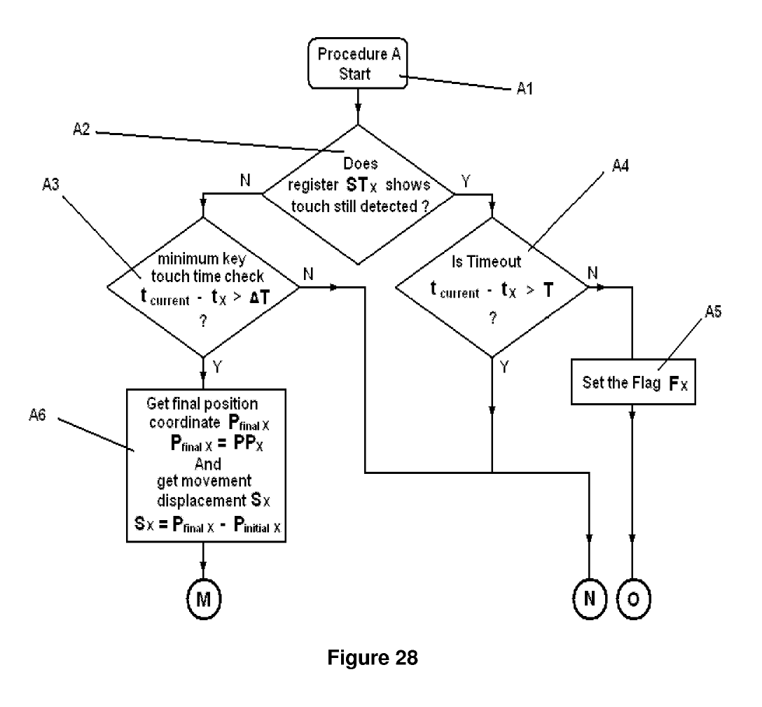

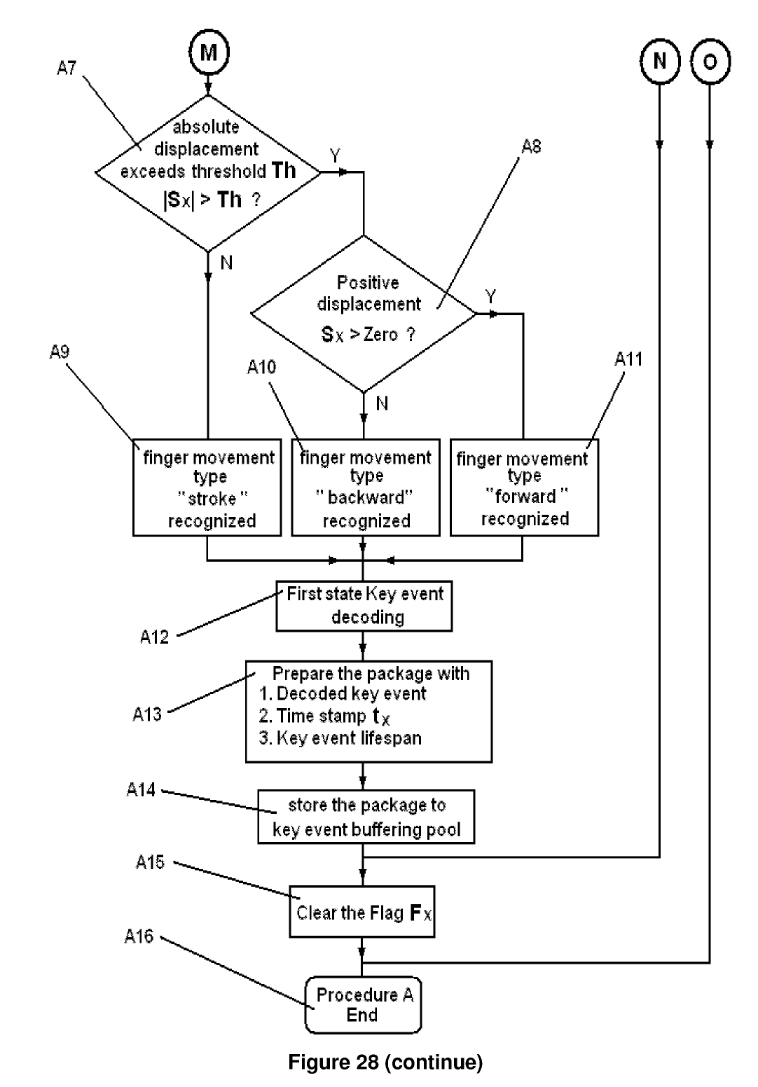

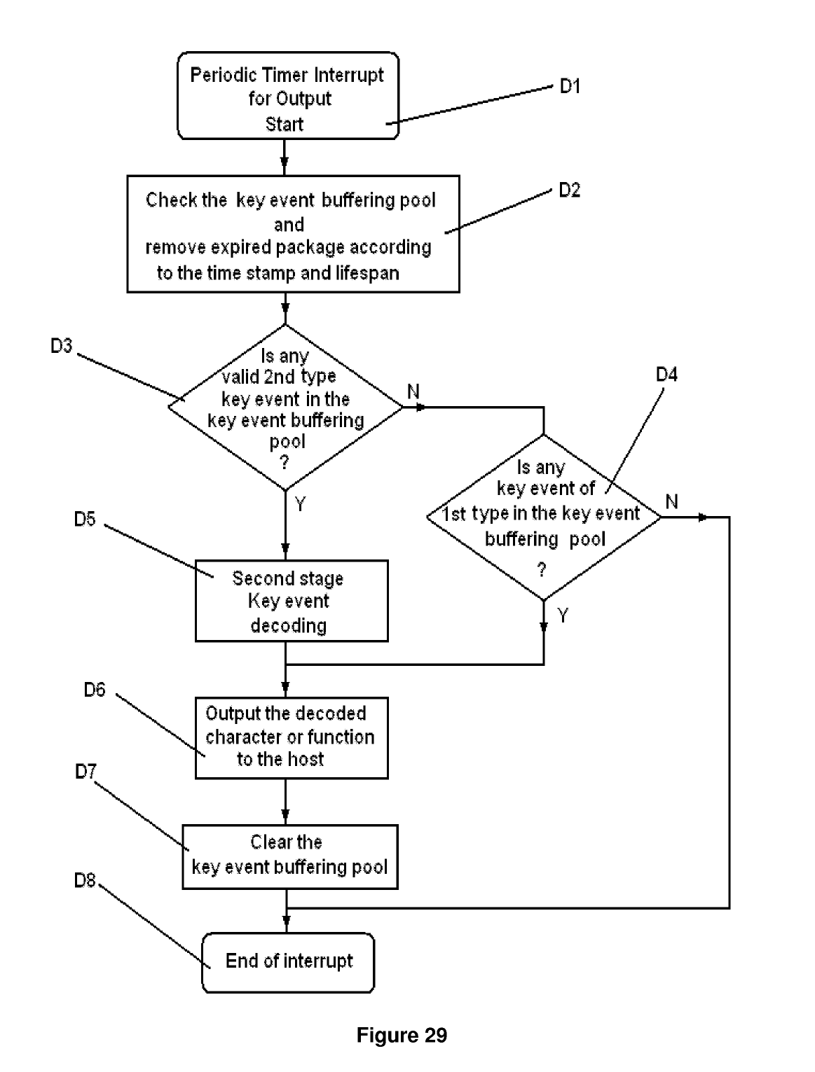

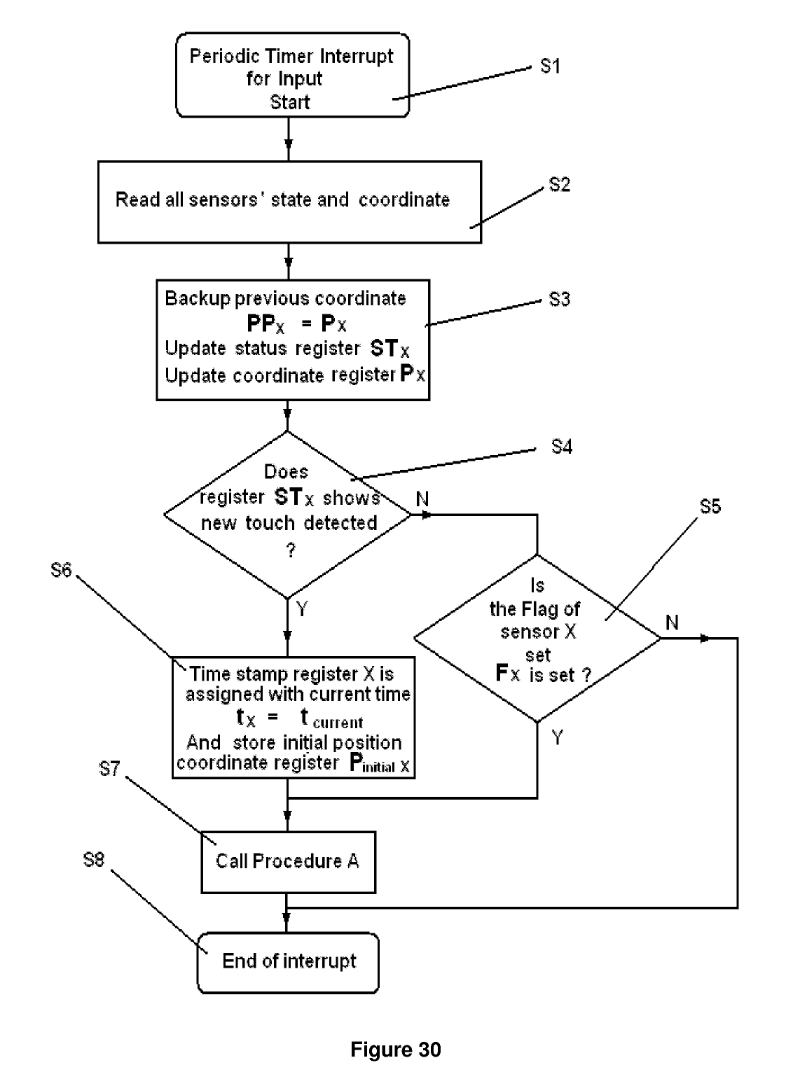

In order to achieve the operation to support the hardware, a controller operation flow of the handheld input device has been defined mainly as 3 parts, namely 1) Processing, 2) Output, and 3) Input as follows (refer to FIGS. 28-30):

### 1) Processing

Procedure A Start (step A1)

Procedure A is activated by timer interrupt while a touch is detected. It will determine the valid finger movement and decode to preliminary key event accordingly. X can be from 1 to 10 according to the sensor sequence number.

Does register ST_{X} show that a touch is still detected? (step A2)

It is to determine whether the operator has released the finger from the sensor. The finger movement will be decoded once the touch is released.

Minimum key touch time check t_{current}−t_{X}>ΔT? (step A3)

The comparison with minimum key touch duration provides a mean to neglect possible short false key event triggering.

Is Timeout t_{current}−d tₓ>T? (step A4)

The Timeout T is a constant which is a predefined time interval to determine the maximum allowable time interval for the finger to touch and release the sensor. The Timeout constant shall be adjustable by the operator under his/her preference.

Set the Flag Fx (step A5)

It is to indicate that a touch has been detected previously but not yet timeout.

Get final position coordinate P_{final X}, P_{final X}=PP_{X} and get movement displacement S_{X}, S_{X}=P_{final X}−P_{initial X} (step A6)

The final finger position coordinate shall be the last coordinate before touch releasing. The finger movement displacement can be obtained from the coordinate difference between P_{final X} and P_{initial X}.

Absolute displacement exceeds threshold Th, |S_{X}|>Th? (step A7)

The Threshold Th is a constant with the minimum displacement of finger movement to be considered as forward and backward moving rather than stroke. The Threshold Th shall be adjustable by the operator under his/her preference.

Positive displacement, S_{X}>Zero (step A8)

It is to determine whether the finger movement is in the forward or backward direction.

Finger movement type “stroke” recognized (step A9)

It is the output result in Procedure A and it can be decoded as key stroke from the operator's specific finger on the sensor.

Finger movement type “backward” recognized (step A10)

It is the result in Procedure A and it can be decoded as backward direction movement of the operator's finger.

Finger movement type “forward” recognized (step A11)

It is the result in Procedure A and it can be decoded as forward direction movement of the operator's finger.

First state Key event decoding (step A12)

It is to decode the finger movement to Key event according to table 1 and table 2.

Prepare the package with 1) Decoded key event, 2) Time stamp t_{X}, 3) Key event lifespan (step A13)

If the finger action is recognized as a valid key event, the decoded key event, Time stamp, lifespan can be packed to a specific data format in a package. Time stamp is exactly the time of first touch of finger to sensor X. The lifespan for a different key event can be different. For example, key event F1 for “Ctrl” key and key event F3 for “Alt” have longer lifespan to stay in the key event buffering pool with up to few seconds. Key event F2 for “Shift” has lifespan of a second and Ordinary key event will have lifespan in hundred mini second. The lifespan of each key event shall be able to be altered by the host.

Store the package to key event buffering pool (step A14)

The resultant package is sent to key event buffering pool.

Clear the Flag F_{X} (step A15)

It is to indicate that the touch movement is finished.

Procedure A End (step A16)

It is the end of the procedure A.

### 2) Output

Periodic Timer Interrupt for Output Start (step D1)

A timer interrupt routine shall be called periodically with the time interval which is defined as the maximum key response delay and the time interval of this interrupt shall be programmable by the host controller under the operator's preference.

Check the key event buffering pool and remove expired package according to the time stamp and lifespan (step D2)

The key event buffering pool is the memory space for Procedure A to store the key event in a short period up to few seconds. If the time stamp plus the lifespan of a specific package exceed the current time, it will be considered as dead or expired package and shall be removed.

Is any valid 2^{nd} type key event in the key event buffering pool? (step D3)

It is the step to find out any key event of 2^{nd} and 3^{rd} type in a short interval. It makes higher priority for key event of 2^{nd} and 3^{rd} type than key event of 1^{st} type to be recognized.

Is any key event of 1^{st} type in the key event buffering pool (step D4)

It is the step to look for 1^{st} type key event. If the result is negative, it will be considered as no input of both single key and key combination from the operator.

Second stage Key event decoding (step D5)

As some key events are the combination of other key events, translation should be applied before decoding. For examples, if key event L6, L9, L12, L15 is found in the key event buffering pool, the processing unit will translate it to key event L18 for decoding. If key event L4 and L7 exist in the key event buffering pool, it will be translated to key event L1 for decoding. Decoding process will consider the factors of the current mode (Symbol, Alpha, Function) and the existence of key event F1, F2 and F3 in the key event buffering pool

Output the decoded character or function to the host (step D6)

It is to output the decoded character to the host controller.

Clear the key event buffering pool (step D7)

After outputting the character or function to the host, all packages in the event buffering pool shall be cleared to avoid continuous effect.

End of interrupt (step D8)

It is the end of interrupt for output and return resource to the system.

### 3) Input

Periodic Timer Interrupt for Input Start (step S1)

It is the periodic timer interrupt routine with very short time interval and highest interrupt priority for detection handling of all touch movement sensors.

Read all sensors' state and coordinate (step S2)

As the movement of each finger is defined as one dimension, the data obtained from the sensor shall be converted to the signed/unsigned integer to indicate the position of each sensor where the finger touches. This signed/unsigned integer can be treated as one dimensional coordinate of the touch position. The touch state can be determined with the current coordinate and the previous coordinate. The definition of touch state includes 1) no touch 2) new touch 3) touch not released 4) touch newly released.

Backup previous coordinate PP_{X}=P_{X}. Update status register ST_{X}. Update coordinate register P_{X} (step S3)

It is to save the last touch coordinate for movement displacement calculation in Procedure A. The touch status register and one dimensional coordinate register for sensor X will be stored for retrieval in Procedure A.

Does register ST_{X} shows new touch detected? (step S4)

If new touched is detected, Procedure A shall be called to proceed the movement classification.

Is the Flag of sensor X set, F_{X} set? (step S5)

It is to indicate that the finger is not yet released from the sensor X and it is not yet timeout.

Time stamp register t_{X} is assigned with current time t_{current}, t_{X}=t_{current} and store initial position coordinate register P_{initial X} (step S6)

It is to save the time at the moment of first touch and Procedure A will use it to check the time out and the minimum touch duration.

Call Procedure A (step S7)

Procedure A is used to determine if the touch on the sensor is too long or not and classify the finger touch movement to “stroke”, “backward”, and “forward”. The manipulated result will be stored in the format of data package at the Key event buffering pool.

End of interrupt (step S8)

It is the end of interrupt to return the resource to the system.

While the handheld input device disclosed in the present application has been shown and described with particular references to a number of preferred embodiments thereof, it should be noted that various other changes or modifications may be made without departing from the scope of the appending claims.

What is claimed is:

1. A portable computer comprising:
(a) a housing;
(b) a display screen connected to the housing, the housing comprising a top surface and a bottom surface, the top surface generally facing an operator during inputting, and the bottom surface generally facing away from the operator during inputting; and
(c) first and second groups of touch movement sensors comprising generally parallel elongated sensing surfaces, the first and second groups of touch movement sensors being provided respectively at the two opposite sides of the housing on the bottom surface thereof, and sized and shaped to be accessible by the fingers of the two hands of the operator holding the housing at the two opposite sides.

2. The portable computer as claimed in claim 1, wherein the first group of touch movement sensors comprises first, second, third and fourth touch movement sensors accessible by the left index finger, left middle finger, left ring finger and left little finger respectively; and wherein the second group of touch movement sensors comprises first, second, third and fourth touch movement sensors accessible by the right index finger, right middle finger, right ring finger and right little finger respectively.

3. The portable computer as claimed in claim 1, wherein the first group of touch movement sensors further comprises a fifth touch movement sensor adjacent to the first touch movement sensor in the first group and accessible by the left index finger; and wherein the second group of touch movement sensors further comprises a fifth touch movement sensor adjacent to the first touch movement sensor in the second group and accessible by the right index finger.

4. The portable computer as claimed in claim 1, wherein the touch movement sensors are touch and two-directional movement sensors for detecting the touching of the fingers as well as the movement of the fingers in the forward and backward directions along the elongated sensing surfaces of the sensors.

5. The portable computer as claimed in claim 1, wherein each elongated sensing surface has a concaved cross section.

6. The portable computer as claimed in claim 1, wherein each elongated sensing surface has a width of a finger.

7. The portable computer as claimed in claim 1, further comprising two touch pads provided at the two opposite sides of the housing on a top surface thereof for operation by the two thumbs of the operator respectively.

8. The portable computer as claimed in claim 1, further comprising a conventional keyboard provided on a top surface of the housing.

9. The portable computer as claimed in claim 1, wherein the first and second groups of touch movement sensors are connected to a processing unit, which is in turn connected to a host.

10. The portable computer as claimed in claim 1, further comprising a wired or wireless digital interface for connecting the portable computer to another device.

11. The portable computer as claimed in claim 1, wherein different finger actions on different touch movement sensors are decoded as different key events each corresponding to a character or a function.

12. The portable computer as claimed in claim 11, further comprising a program for changing the matching of key events to characters and functions.

13. The portable computer as claimed in claim 11, wherein the finger actions start at any initial touch point on the touch movement sensors.

14. The portable computer as claimed in claim 1, wherein the display screen is pivotally connected to the housing by a hinge allowing the display screen to flip forward and backward as well as rotate 180 degrees.

15. The portable computer as claimed in claim 14, wherein the angle between the display screen and the housing is about 90-180 degrees when the operator is holding the housing at a substantially horizontal position while inputting.

16. The portable computer as claimed in claim 15, wherein the angle between the display screen and the housing is about 160 degrees.

17. The portable computer as claimed in claim 14, wherein the angle between the display screen and the housing is about 180-270 degrees when the operator is holding the housing at a substantially vertical position while inputting.

18. The portable computer as claimed in claim 17, wherein the angle between the display screen and the housing is about 220 degrees.

19. The portable computer as claimed in claim 14, wherein the angle between the display screen and the housing is about 0-90 degrees when the operator is holding the housing at a substantially vertical position while inputting and the display screen is rotated 180 degrees.

20. The portable computer as claimed in claim 18, wherein the angle between the display screen and the housing is about 40 degrees.

21. A handheld input device comprising:
(a) a housing; and
(b) first and second groups of touch movement sensors provided respectively at two opposite sides of the housing on a bottom surface thereof, and sized and shaped to be accessible by the fingers of the two hands of an operator holding the housing at the two opposite sides.

22. The handheld input device as claimed in claim 21, wherein each group of touch movement sensors comprises generally parallel elongated sensing surfaces.

23. The handheld input device as claimed in claim 21, wherein the first group of touch movement sensors comprises first, second, third and fourth touch movement sensors accessible by the left index finger, left middle finger, left ring finger and left little finger respectively; and wherein the second group of touch movement sensors comprises first, second, third and fourth touch movement sensors accessible by the right index finger, right middle finger, right ring finger and right little finger respectively.

24. The handheld input device as claimed in claim 21, wherein the first group of touch movement sensors further comprises a fifth touch movement sensor adjacent to the first touch movement sensor in the first group and accessible by the left index finger; and wherein the second group of touch movement sensors further comprises a fifth touch movement sensor adjacent to the first touch movement sensor in the second group and accessible by the right index finger.

25. The handheld input device as claimed in claim 22, wherein the touch movement sensors are touch and two-directional movement sensors for detecting the touching of the fingers as well as the movement of the fingers in the forward and backward directions along the elongated sensing surfaces of the sensors.

26. The handheld input device as claimed in claim 22, wherein each elongated sensing surface has a concaved cross section.

27. The handheld input device as claimed in claim 22, wherein each elongated sensing surface has a width of a finger.

28. The handheld input device as claimed in claim 21, further comprising two touch pads provided at the two opposite sides of the housing on a top surface thereof for operation by the two thumbs of the operator respectively.

29. The handheld input device as claimed in claim 21, further comprising a conventional keyboard provided on a top surface of the housing.

30. The handheld input device as claimed in claim 21, wherein the first and second groups of touch movement sensors are connected to a processing unit, which is in turn connected to a host.

31. The handheld input device as claimed in claim 21, wherein different finger actions on different touch movement sensors are decoded as different key events each corresponding to a character or a function.

32. The handheld input device as claimed in claim 31, comprising memory space for buffering a recent key event to yield combination key events.

33. The handheld input device as claimed in claim 31, wherein the key event is stored in a memory buffer with an expiry mechanism based on the individual lifespan and time stamp of the key event.

34. The handheld input device as claimed in claim 31, wherein the sensors detect concurrent movement of fingers of both hands of the operator for character/function decoding to the host.

35. The handheld input device as claimed in claim 31, wherein the finger actions include “touch and release”, “touch, move to the left, and then release” and “touch, move to the right, and then release”.

36. The handheld input device as claimed in claim 31, wherein the finger actions start at any initial touch point on the touch movement sensors.

37. The handheld input device as claimed in claim 21, further comprising a program for changing the matching of key events to characters and functions.

38. The handheld input device as claimed in claim 21, further comprising a wired or wireless digital interface for connecting the input device to a computing device.
